(19) United States
(12) Patent Application Publication
(10) Pub. No.: US 2009/0267248 A1
(43) Pub. Date: Oct. 29, 2009

(54) PROCESS FOR FABRICATING MOLDING STAMP

(75) Inventor: TAI-CHERNG YU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/192,363

(22) Filed: Aug. 15, 2008

(30) Foreign Application Priority Data
Apr. 28, 2008 (CN) 200810301352.5

(51) Int. Cl. B29D 11/00

(52) U.S. Cl. 264/1.38

(57) ABSTRACT

A process for fabricating a molding stamp mainly includes the steps of: (1) attaching a framework onto a substrate, the framework defining a number of through holes therein so that the framework and the substrate cooperatively define a number of molding cavities; (2) applying a UV curable resin in one of the molding cavities; (3) molding the UV curable resin in the one of the molding cavities using a printing stamp having a predetermined microlens pattern; (4) curing the UV curable resin to form a microlens unit; (5) removing the printing stamp; (6) repeating the steps (2) through (5) to form a number of microlens units on the substrate; (7) removing the framework from the substrate; (8) applying a thermosetting resin on the substrate to cover the microlens units; (9) curing the thermosetting resin to form the molding stamp; and (10) separating the molding stamp from the substrate.

### BACKGROUND

1. Technical Field

The present invention relates to a process for fabricating a molding stamp, and particularly, to a ultraviolet (UV) imprint process for fabricating a molding stamp having a pattern corresponding to a plurality of microlens.

2. Description of Related Art

A conventional process for making a molding core typically includes the following steps: disposing a photo resist on a substrate; exposing the photo resist under light and developing the photo resist; etching the substrate to form a pattern and removing the photo resist; electroforming a body on the substrate; removing the substrate from the electroformed body to obtain the molding core.

However, the process is complex and time-consuming because of its numerous steps, such as etching and electroplating. Thus, the efficiency of the process is accordingly reduced.

Therefore, a new process for fabricating a molding stamp is desired to overcome the above mentioned problems.

### SUMMARY

An exemplary process for fabricating a molding stamp includes the steps of: (1) attaching a framework onto a substrate, the framework defining a number of through holes therein so that the framework and the substrate cooperatively define a number of molding cavities; (2) applying a UV curable resin in one of the molding cavities; (3) molding the UV curable resin in the one of the molding cavities using a printing stamp having a predetermined microlens pattern, so that the predetermined microlens pattern is transferred to an upper surface of the UV curable resin; (4) irradiating ultraviolet rays onto the UV curable resin to cure the UV curable resin to form a microlens unit; (5) removing the printing stamp from the UV curable resin; (6) repeating the steps (2) through (5) to form a number of microlens units on the substrate; (7) removing the framework from the substrate; (8) applying a thermosetting resin on the substrate to cover the number of microlens units; (9) curing the thermosetting resin to form the molding stamp having a pattern corresponding to the number of microlens units; and (10) separating the molding stamp from the substrate.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIGS. 1A to 1G are sectional views of successive stages of a process for fabricating a molding stamp, according to a first embodiment.

FIG. 2 is a sectional view for describing a step of contacting a cover to an upper surface of a second curable resin, according to another alternative embodiment.

FIG. 3 is a flow chart of a process for fabricating a molding stamp, according to a second embodiment.

### DETAILED DESCRIPTION OF THE EMBODIMENTS

Embodiments will now be described in detail below with reference to the drawings.

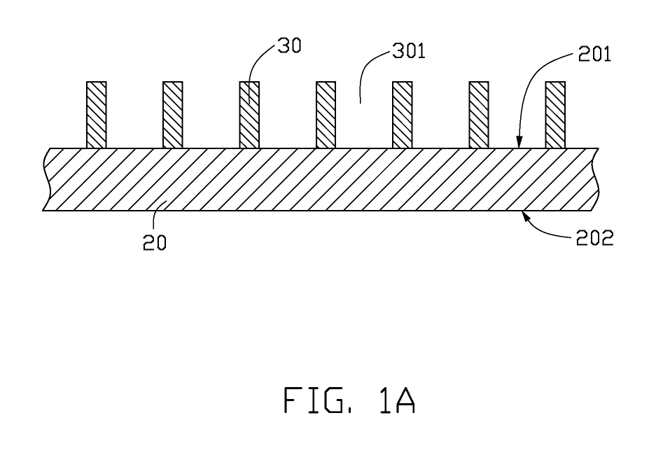

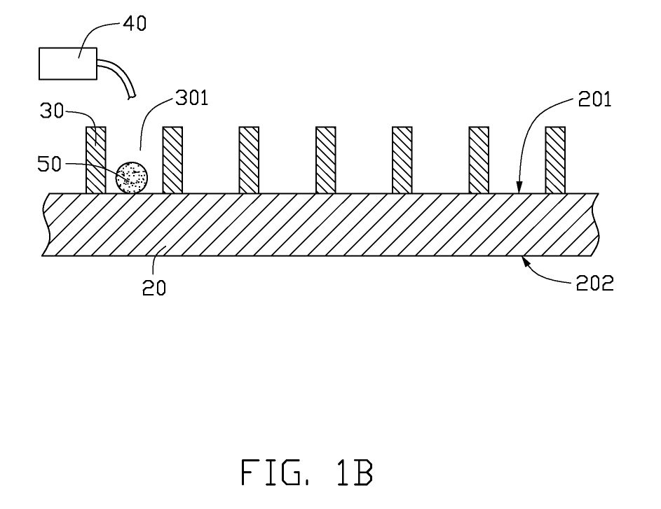

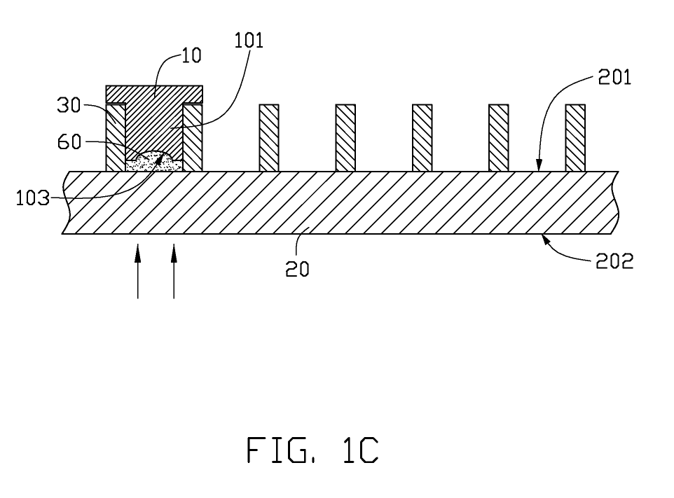

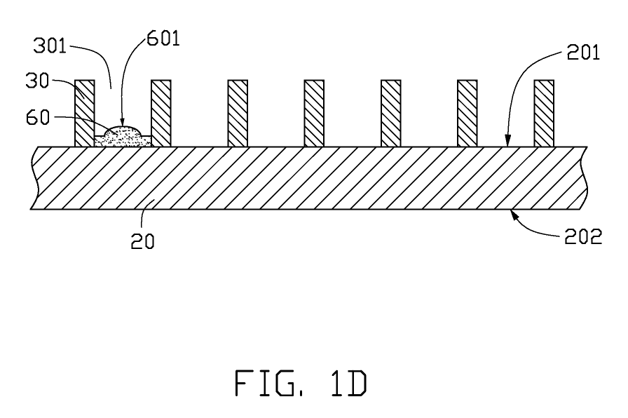

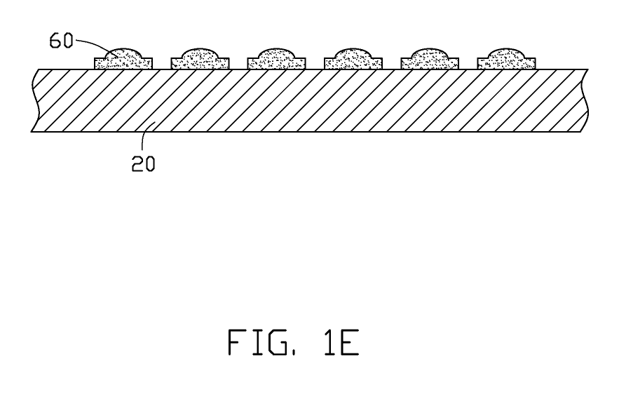

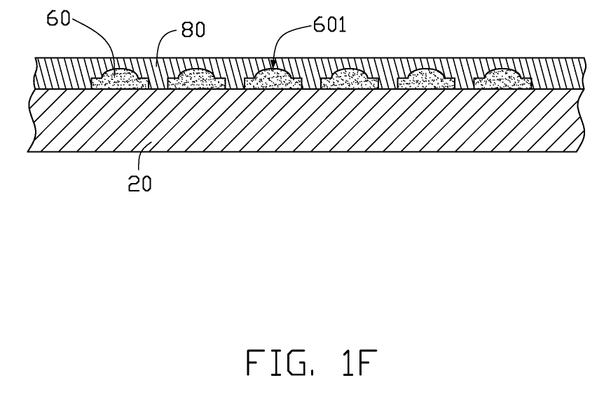

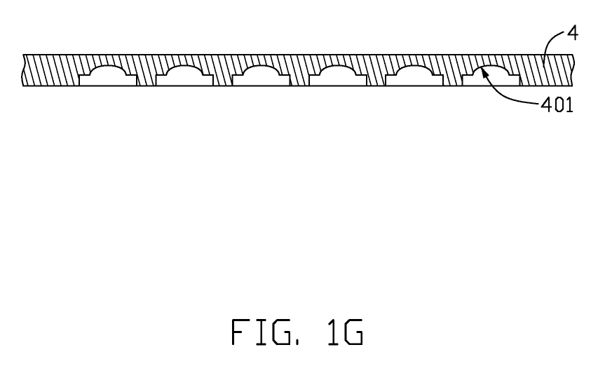

Referring to FIGS. 1A-1G, a process for fabricating a molding stamp 4 (referring to FIG. 1G) is provided herein according to a first embodiment of the present invention. The process for fabricating the molding stamp 4 (see FIG. 1G) generally includes the steps of:
1) attaching a framework 30 onto a substrate 20, the framework 30 defining a number of through holes therein so that the framework 30 and the substrate 20 cooperatively define a number of molding cavities 301;
(2) applying a UV curable resin 50 in one of the molding cavities 301;
(3) molding the UV curable resin 50 in the one of the molding cavities 301 using a printing stamp 10 having a predetermined microlens pattern, so that the predetermined microlens pattern is transferred to an upper surface of the UV curable resin 50;
(4) irradiating ultraviolet rays onto the UV curable resin 50 to cure the UV curable resin 50 to form a microlens unit 60;
(5) removing the printing stamp 10 from the UV curable resin 50;
(6) repeating the steps (2) through (5) to form a number of microlens units 60 on the substrate 20;
(7) removing the framework 30 from the substrate 20;
(8) applying a thermosetting resin 80 on the substrate 20 to cover the number of microlens units 60;
(9) curing the thermosetting resin 80 to form the molding stamp 4 having a pattern corresponding to the number of microlens units 60; and
(10) separating the molding stamp 4 from the substrate 20.

In detail, referring to FIG. 1A, the substrate 20 having a first surface 201 and an opposite second surface 202 is provided. A framework 30 is placed on the first surface 201 of the substrate 20. The framework 30 is a plate defining a number of through holes (not labeled) therein, such as a grid including a number of crisscrossed bars. Correspondingly, the framework 30 and the substrate 20 cooperatively define a number of molding cavities 301. The framework 30 is preferably made by super-precision technology. The through holes generally have the same size.

Referring to FIG. 1B, a first curable resin 50 is placed into one of the molding cavities 301 by a resin-supplying device 40. The first curable resin 50 can be made of epoxy resin, acrylic resin, polymethyl methacrylate, or polysilicone resin. In this embodiment, the first curable resin is a UV curable resin. It is known that various methods for disposing the first curable resin on a substrate could be applied, such as spin coating, droplet dispensing, and spray methods.

Referring to FIG. 1C, a printing stamp 10 is contacted to the first curable resin 50. The printing stamp 10 includes a printing portion 101 having a predetermined microlens pattern. The printing stamp 10 preferably has a size coupling with one of the molding cavities 301 such that the printing portion 101 can be received in one of the molding cavities 301. The printing portion 101 is placed into the molding cavity 301 and contacts with an upper surface 103 of the first curable resin 50. An external force is applied to press the printing stamp 10 in a direction toward the substrate 20. Accordingly, the predetermined microlens pattern of the printing stamp 10 is printed onto the upper surface 103 of the first curable resin 50. The first curable resin 50 is cured to form a microlens unit 60 by irradiating ultraviolet rays thereon for a period of time via the surface 202 of the substrate 20. In this embodiment, the substrate 20 is transparent to ultraviolet rays, and can be made of quartz, glass, sapphire, diamond, or the like UV-transmitting materials. The ultraviolet rays are introduced onto the first curable resin 50 through the substrate 20. An area of the substrate 20 exposing to the ultraviolet rays is consistent with the one of the molding cavities 301. Alternatively, the first curable resin 50 may be cured by introducing the ultraviolet rays thereon through the printing stamp 10, where the printing stamp 10 is transparent to the ultraviolet rays.

Referring to FIG. 1D, the printing stamp 10 is separated from the molding cavity 301 after the first curable resin 50 is cured. A microlens unit 60 is thereby formed in the molding cavity 301, and has the predetermined microlens pattern on its top surface 601.

Referring to FIG. 1E, the steps of disposing the first curable resin 50 into another one of the molding cavities 301, contacting and pressing the printing stamp 10 to the upper surface of the first curable resin 50, irradiating the ultraviolet rays onto the first curable resin 50, and separating the printing stamp 10, are sequentially repeated to form a number of the microlens units 60 on the substrate 20, as desired. The framework 30 is then removed from the substrate 20. It is indisputable that an area of the microlens units 60 of the substrate 20 is generally greater than an area of the predetermined microlens pattern of the printing stamp 10.

Referring to FIGS. 1F and 1G, a second curable resin 80 is applied on the substrate 20, and covers the top surfaces 601 of the microlens units 60 for transferring the predetermined microlens patterns thereto. The second curable resin 80 is a thermosetting resin, such as epoxy resin, acrylic resin, polymethyl methacrylate, polysilicone resin. The second curable resin 80 is cured to form the molding stamp 4 by heating for a period of time to a curing temperature thereof. The molding stamp 4 is then separated from the substrate 20. The molding stamp 4 having a pattern 401 corresponding to the number of microlens units 60 is thereby formed.

It should be noted that the steps of curing the first and second curable resins 50, 80 could be performed in other means, e.g., the first curable resin 50 is cured by heating for a period of time to a curing temperature thereof. Further, the second curable resin 80 may be cured by irradiating light thereon for a period of time at ambient temperature when the second curable resin 80 is a photo curable resin, such as a UV curable resin.

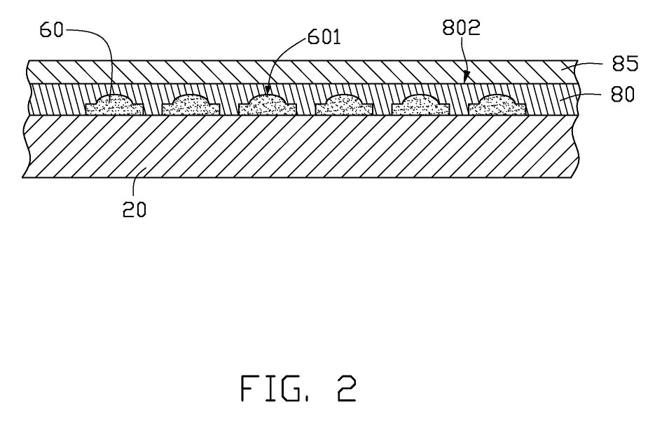

Referring to FIG. 2, in another alternative embodiment, the process further includes a step of placing a cover 85 to an upper surface 802 of the second curable resin 80 between the steps of disposing and curing the second curable resin 80. The cover 85 is contacted to the upper surface 802 and pressed towards the substrate 20 to make the pattern of the microlens units 60 completely printed onto the second curable resin 80. It is preferable that the upper surface 802 of the second curable resin 80 is pressed to be flat by the cover 85.

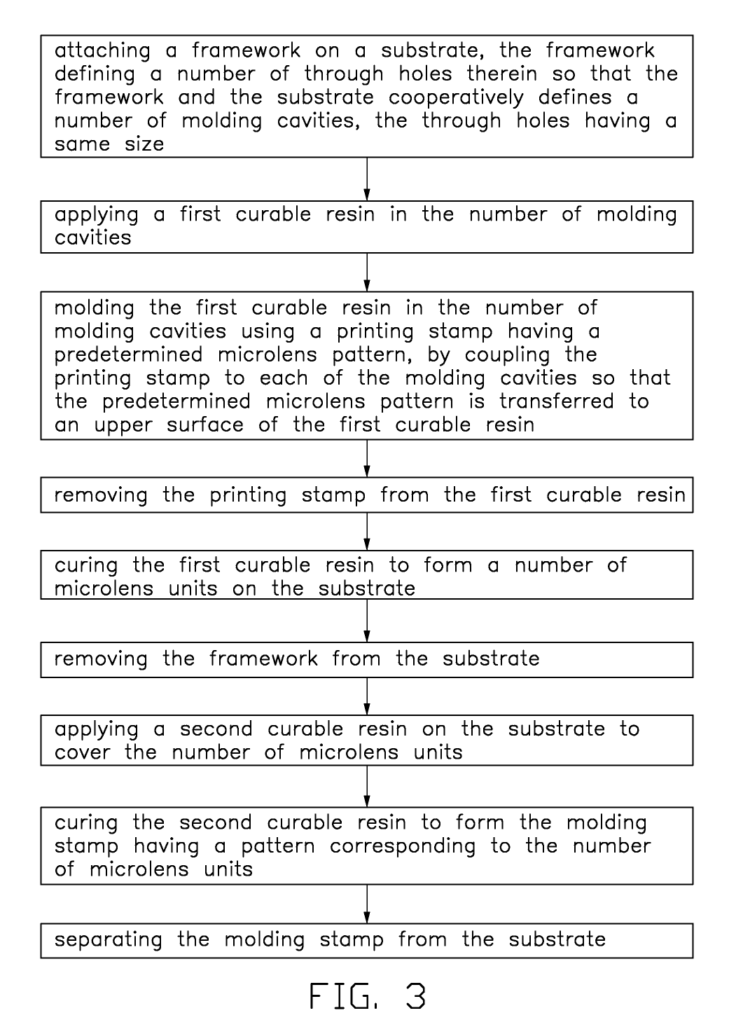

Referring to FIG. 3, a process for fabricating the molding stamp in accordance with a second embodiment is shown. The process generally includes the steps of: attaching a framework on a substrate, the framework defining a number of through holes therein so that the framework and the substrate cooperatively defines a number of molding cavities, the through holes having a same size; applying a first curable resin in the number of molding cavities; molding the first curable resin in the number of molding cavities using a printing stamp having a predetermined microlens pattern, by coupling the printing stamp to each of the molding cavities so that the predetermined microlens pattern is transferred to an upper surface of the first curable resin; removing the printing stamp from the first curable resin; curing the first curable resin to form a number of microlens units on the substrate; removing the framework from the substrate; applying a second curable resin on the substrate to cover the number of microlens units; curing the second curable resin to form the molding stamp having a pattern corresponding to the number of microlens units; and separating the molding stamp from the substrate.

In particular, compared with the first embodiment, the first curable resin of the second embodiment is placed in each one of the molding cavities, not only one of the molding cavities, and is then imprinted and cured respectively.

While certain embodiments have been described and exemplified above, various other embodiments from the foregoing disclosure will be apparent to those skilled in the art. The present invention is not limited to the particular embodiments described and exemplified but is capable of considerable variation and modification without departure from the scope of the appended claims.

1. A process for fabricating a molding stamp, comprising:
(1) attaching a framework onto a substrate, the framework defining a plurality of through holes therein so that the framework and the substrate cooperatively define a plurality of molding cavities;
(2) applying an ultraviolet (UV) curable resin in one of the molding cavities;
(3) molding the UV curable resin in the one of the molding cavities using a printing stamp having a predetermined microlens pattern, so that the predetermined microlens pattern is transferred to an upper surface of the UV curable resin;
(4) irradiating ultraviolet rays onto the UV curable resin to cure the UV curable resin to form a microlens unit;
(5) removing the printing stamp from the UV curable resin;
(6) repeating steps (2) through (5) to form a plurality of microlens units on the substrate;
(7) removing the framework from the substrate;
(8) applying a thermosetting resin on the substrate to cover the plurality of microlens units;
(9) curing the thermosetting resin to form the molding stamp having a pattern corresponding to the plurality of micro lens units; and
(10) separating the molding stamp from the substrate.

2. The process of claim 1, wherein the substrate is transparent to the ultraviolet rays, and the ultraviolet rays are irradiated onto the UV curable resin through the substrate.

3. The process of claim 1, further comprising placing a cover onto an upper surface of the thermosetting resin prior to step (9).

4. The process of claim 1, wherein an area of the substrate exposed to the ultraviolet rays is aligned with the one of the molding cavities.

5. A process for fabricating a molding stamp, comprising:
attaching a framework on a substrate, the framework defining a plurality of through holes therein so that the framework and the substrate cooperatively defines a plurality of molding cavities, the through holes having a same size;
applying a first curable resin in the plurality of molding cavities;
molding the first curable resin in the plurality of molding cavities using a printing stamp having a predetermined microlens pattern, by coupling the printing stamp to each of the molding cavities so that the predetermined microlens pattern is transferred to an upper surface of the first curable resin;
removing the printing stamp from the first curable resin;
curing the first curable resin to form a plurality of microlens units on the substrate;
removing the framework from the substrate;
applying a second curable resin on the substrate to cover the plurality of microlens units;
curing the second curable resin to form the molding stamp having a pattern corresponding to the plurality of microlens units; and
separating the molding stamp from the substrate.

6. The process of claim 5, wherein the substrate is transparent to light, the step of curing the first curable resin is performed by irradiating light onto the first resin through the substrate.

7. The process of claim 6, wherein an area of the substrate exposed to the light is aligned with each of the molding cavities.

8. The process of claim 5, wherein curing the first curable resin is performed by irradiating light onto the first curable resin or heating the first curable resin to a curing temperature thereof.

9. The process of claim 5, wherein curing the second curable resin is performed by irradiating light onto the second curable resin or heating the second curable resin to a curing temperature thereof.

10. The process of claim 5, further comprising attaching a cover onto an upper surface of the second curable resin prior to curing the second curable resin.

11. A process for fabricating a molding stamp, comprising the steps of:
attaching a framework onto a substrate, the framework defining a plurality of through holes therein so that the framework and the substrate cooperatively define a plurality of molding cavities;
engaging a print stamp in each of the molding cavities to form a plurality of lens units on the substrate in the molding cavities using a first curable resin, the printing stamp having a predetermined lens pattern which is transferred to an upper surface of the each lens unit;
removing the framework from the substrate;
applying a second curable resin on the substrate to completely cover the plurality of lens units; curing the second curable resin to form the molding stamp having a pattern corresponding to the plurality of lens units; and
separating the molding stamp from the substrate.

12. The process of claim 11, wherein curing the second curable resin is performed by irradiating light onto the second curable resin or heating the second curable resin to a curing temperature thereof

13. The process of claim 11, farther comprising a step of attaching a cover onto an upper surface of the second curable resin prior to curing the second curable resin.

14. The process of claim 11, wherein the first and second curable resins are comprised of epoxy resin, acrylic resin, polymethyl methacrylate, or polysilicone resin.

15. The process of claim 11, further comprising the steps of:
applying the first curable resin into each of the molding cavities after the step of attaching a framework onto a substrate; and
curing the first curable resin in each of the molding cavities and then removing the print stamp from the first curable resin, wherein the substrate is transparent to light, and curing the first curable resin is performed by irradiating light onto the first curable resin through the substrate.

16. The process of claim 15, wherein an area of the substrate exposed to the light is aligned with each of the molding cavities.

17. The process of claim 15, wherein the light is ultraviolet rays, and the first curable resin is an ultraviolet curable resin.
